(19) United States
(12) Patent Application Publication
(10) Pub. No.: US 2014/0354478 A1
(43) Pub. Date: Dec. 4, 2014

(54) COMMUNICATION SYSTEM, CONTROL APPARATUS, CONTROL METHOD, AND STORAGE MEDIUM

(71) Applicant: CANON KABUSHIKI KAISHA, Tokyo (JP)

(72) Inventor: Makoto Umehara, Kawasaki-shi (JP)

(73) Assignee: CANON KABUSHIKI KAISHA, Tokyo (JP)

(21) Appl. No.: 14/291,521

(22) Filed: May 30, 2014

(30) Foreign Application Priority Data
Jun. 3, 2013 (JP) 2013-117377

(51) Int. Cl. H01Q 3/30

(52) U.S. Cl. CPC H01Q 3/30
USPC 342/367

(57) ABSTRACT

In a communication system including a transmission apparatus which includes a transmission antenna capable of changing a direction of directivity and a reception apparatus which includes a reception antenna capable of changing a direction of directivity, one of the transmission apparatus and the reception apparatus obtains the time of arrival of a radio wave for each of a plurality of pairs of the directions of directivity of the transmission antenna and reception antenna, and extracts a plurality of pairs of the directions of directivity to be used for communication so that the difference between the time of arrival for one of the pairs and the time of arrival for another one of the pairs is not shorter than a predetermined time.

### BACKGROUND OF THE INVENTION

1. Field of the Invention

The present invention relates to a communication technique using a directional antenna.

2. Description of the Related Art

To wirelessly transmit a large amount of data such as video data and audio data at high speed, a millimeter wave wireless technique using the 60-GHz band in which it is possible to ensure a wide bandwidth is attracting attention. On the other hand, it is known that as a frequency is higher, the straightness of a radio wave increases. When a millimeter wave is used, if an object such as a human body which shields a communication path exists, communication may become impossible. To solve this problem, a technique of searching for a plurality of communication paths in which it is possible to ensure high communication quality while changing the direction of directivity of a directional antenna, and transmitting data using the plurality of communication paths has been studied (see Japanese Patent Laid-Open No. 2012-186566).

Japanese Patent Laid-Open No. 2012-186566 describes a technique of transmitting the same data using a plurality of spatially separated communication paths. In this technique, even if a shielding object exists midway along a communication path, communication using a different communication path is not interrupted at high probability, thereby allowing reliable communication.

In Japanese Patent Laid-Open No. 2012-186566, as a plurality of communication paths used for data transmission are spatially separated farther away from each other, the probability that all the communication paths are simultaneously shielded is lower, thereby allowing reliable communication. In general, however, the antenna pattern of a directional antenna includes not only a main lobe having the gain peak in the direction of directivity but also side lobes each having the gain peak in a direction different from the direction of directivity. Even if a radio wave emitted from the main lobe of a transmission antenna is not received in the main lobe direction of a reception antenna, a signal may be received with a sufficiently high power when a radio wave emitted from the side lobe is received in the side lobe direction. This situation will be described with reference to FIGS. 13A and 13B.

In FIGS. 13A and 13B, a transmission apparatus 1300 and reception apparatus 1301 measure the communication quality while changing the directions of directivity of their transmission antenna and reception antenna. Assume that predetermined communication quality is satisfied in the directions of directivity shown in FIGS. 13A and 13B. Referring to FIG. 13A, a signal transmitted from the main lobe of the transmission antenna of the transmission apparatus 1300 is received by the main lobe of the reception antenna of the reception apparatus 1301 via a communication path 1302. On the other hand, referring to FIG. 13B, a signal transmitted from the side lobe of the transmission antenna of the transmission apparatus 1300 is received by the side lobe of the reception antenna of the reception apparatus 1301 via the communication path 1302. Note that in FIG. 13B, the power of the signal transmitted from the main lobe of the transmission antenna of the transmission apparatus 1300 attenuates by passing through a communication path 1304, and the signal is not thus received by the main lobe of the reception antenna of the reception apparatus 1301. In this case, the directions of directivity of the transmission antenna and reception antenna in FIG. 13A are different from those in FIG. 13B but the antennas transmit/receive a signal via the same communication path 1302.

In Japanese Patent Laid-Open No. 2012-186566, since the transmission apparatus 1300 and reception apparatus 1301 search for communication paths based on the communication quality and the directions of directivity of the antennas, it is impossible to detect that the communication path of FIG. 13B is formed by the side lobes. That is, in the example of FIG. 13B, the communication path 1302 is determined as the communication path 1304 formed by a reflective object 1303. As a result, although reliable communication is supposed to be performed using the two communication paths 1302 and 1304, communication is actually performed using only the communication path 1302. Consequently, if the communication path 1302 is blocked, communication is unwantedly interrupted.

The present invention has been made in consideration of the above problem, and allows selection of spatially different communication paths when selecting a plurality of communication paths.

### SUMMARY OF THE INVENTION

According to one aspect of the present invention, there is provided a communication system comprising a transmission apparatus which includes a transmission antenna capable of changing a direction of directivity and a reception apparatus which includes a reception antenna capable of changing a direction of directivity, one of the transmission apparatus and the reception apparatus comprising an obtaining unit configured to obtain a time of arrival of a radio wave for each of a plurality of pairs of the directions of directivity of the transmission antenna and the reception antenna, and an extraction unit configured to extract a pair of the directions of directivity to be used for communication, and extract a plurality of pairs so that a difference between the time of arrival for one of the pairs and the time of arrival for another one of the pairs is not shorter than a predetermined time.

According to one aspect of the present invention, there is provided a control apparatus of a communication system including a transmission apparatus which includes a transmission antenna capable of changing a direction of directivity and a reception apparatus which includes a reception antenna capable of changing a direction of directivity, the control apparatus comprising: an obtaining unit configured to obtain a time of arrival of a radio wave for each of a plurality of pairs of the directions of directivity of the transmission antenna and the reception antenna, and an extraction unit configured to extract a pair of the directions of directivity to be used for communication, and extract a plurality of pairs so that a difference between the time of arrival for one of the pairs and the time of arrival for another one of the pairs is not shorter than a predetermined time.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is a view showing an example of the configuration of a wireless communication system;

FIGS. 2A to 2C are views for explaining antennas;

FIG. 3 is a view showing an example of the format of a communication frame;

FIG. 4 is a block diagram showing an example of the arrangement of a source node;

FIG. 5 is a block diagram showing an example of the arrangement of a destination node;

FIG. 6 is a view for explaining the operation of a frame synchronization unit;

FIG. 7 is a table for explaining the operation of an impulse response storage unit;

FIG. 8 is a flowchart illustrating processing executed by the wireless communication system;

FIG. 9 is a table showing an example of time slot allocation information at the time of a search for communication paths;

FIG. 10 is a table showing an example of time slot allocation at the time of transmission of video data;

FIG. 11 is a block diagram showing another example of the arrangement of the destination node;

FIG. 12 is a flowchart illustrating another example of processing executed by the wireless communication system; and

FIGS. 13A and 13B are views for explaining the problem of the conventional technique.

### DESCRIPTION OF THE EMBODIMENTS

An exemplary embodiment(s) of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

### System Configuration

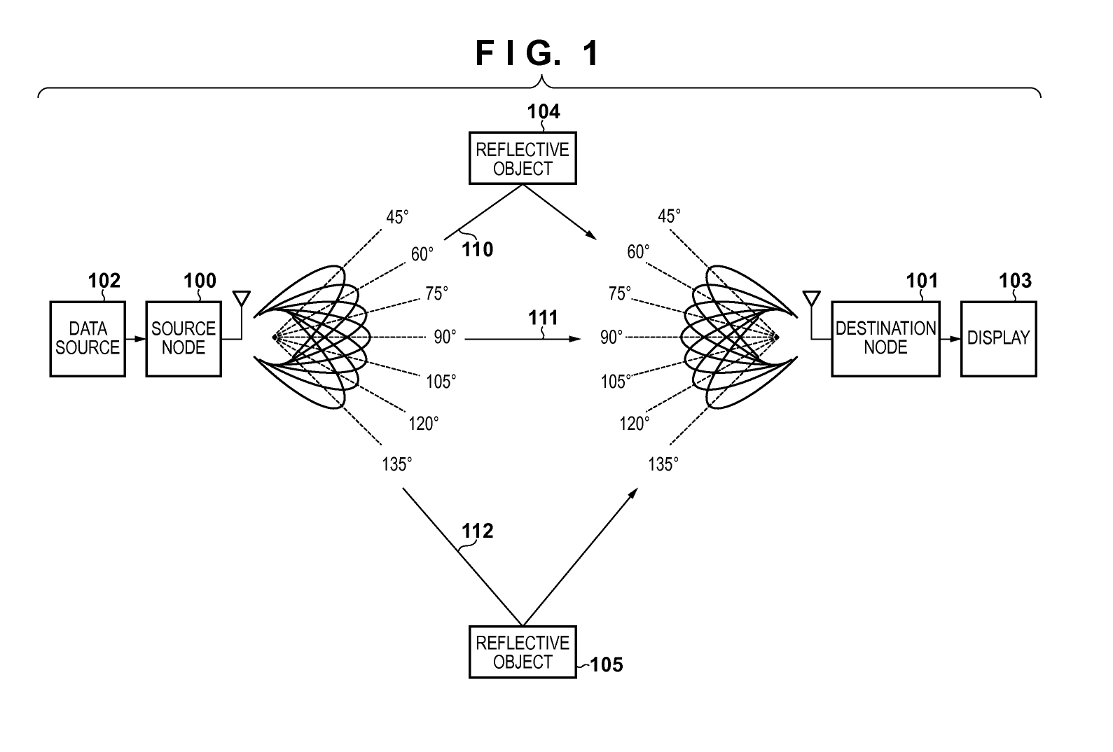

FIG. 1 shows an example of the configuration of a wireless communication system according to the embodiment. In this embodiment, the wireless communication system includes a source node 100 serving as a wireless signal transmission apparatus and a destination node 101 serving as a wireless signal reception apparatus. Assume that the source node 100 includes a directional transmission antenna, and the transmission antenna can adaptively change its direction of directivity. Assume also that the destination node includes a directional reception antenna, and the reception antenna can also adaptively change its direction of directivity.

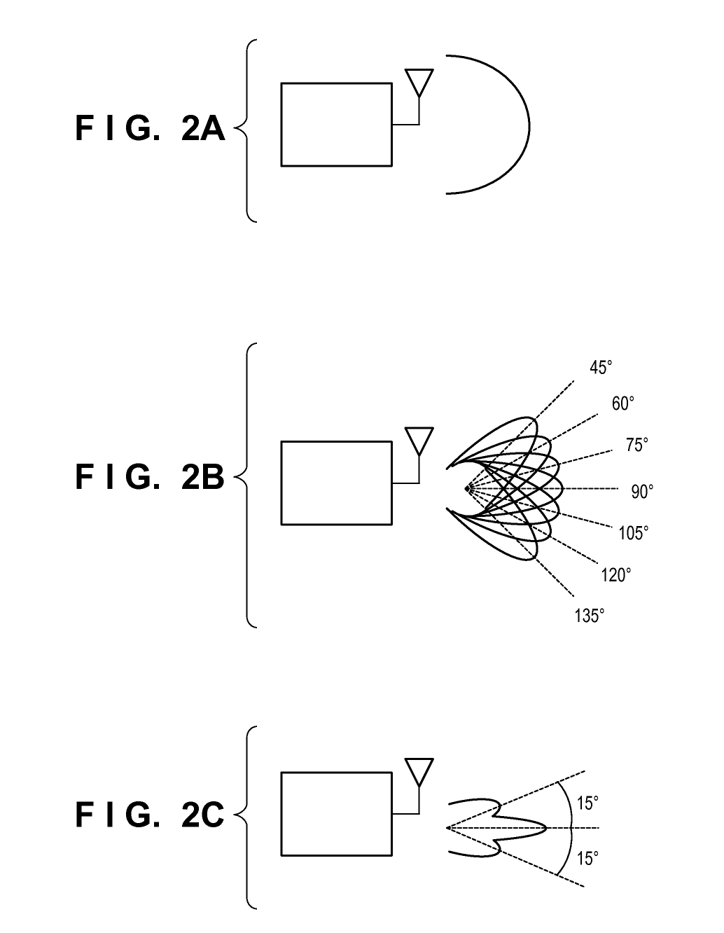

FIGS. 2A to 2C are views for explaining the antennas (transmission antenna and reception antenna) of the source node 100 and destination node 101. Each of the transmission antenna and the reception antenna is formed by, for example, a plurality of antenna elements like an adaptive antenna array. Controlling the phase of a wireless signal transmitted/received by each antenna element can switch a mode between a broad directional mode shown in FIG. 2A and a narrow directional mode shown in FIG. 2B. In this embodiment, assume that in the narrow directional mode, the direction of directivity can be switched between 45° and 135° at a resolution of 15°. Assume also that the antenna directivity in the narrow directional mode includes side lobes in the ±15° directions with respect to the direction of directivity, as shown in FIG. 2C.

In the narrow directional mode, the transmittable/receivable range of a communication path is limited but it is possible to obtain a higher antenna gain than in the broad directional mode. Therefore, the narrow directional mode is appropriate for data transmission at a high rate. In this embodiment, the narrow directional mode is used for transmission of video data which requires a high rate, and the broad directional mode is used for transmission of control data which does not require a high rate. Note that a case in which the control range of the direction of directivity and the characteristics of the resolution and side lobes of the antenna in the narrow directional mode are set to the above-described values will be described below. The present invention, however, is not limited to this. For example, the direction of directivity may be changed every 10°, and the direction of each side lobe need not be 15° with respect to the direction of directivity.

In this embodiment, as shown in FIG. 1, a data source 102 supplies data to the source node 100. In this example, the supplied data is, for example, video data. The video data transmitted by the source node 100 is supplied to a display 103 via the destination node 101, and the display displays and outputs the video.

FIG. 1 shows candidates of communication paths 110 to 112 via which data can be transmitted. In this example, the communication paths 110 to 112 which are usable for data transmission include not only a direct wave (the communication path 111) but also reflected waves (the communication paths 110 and 112) reflected by reflective objects 104 and 105 such as walls.

In this embodiment, the source node 100 and destination node 101 communicate with each other by selecting at least one communication path usable for data transmission, and select and use, for communication, a pair of the directions of directivity of the transmission antenna and reception antenna corresponding to the selected communication path. Note that to improve the reliability of data transmission, when a plurality of communication paths are usable, the source node 100 and destination node 101 select two or more communication paths, and select and use pairs of the directions of directivity corresponding to the selected communication paths. Note also that when two or more communication paths are selected, the source node 100 transmits the same data via each of the selected communication paths. With this arrangement, even if a shielding object exists midway along one communication path, data can be transmitted via the other communication path, thereby continuing the operation of the system without interrupting a video playback operation.

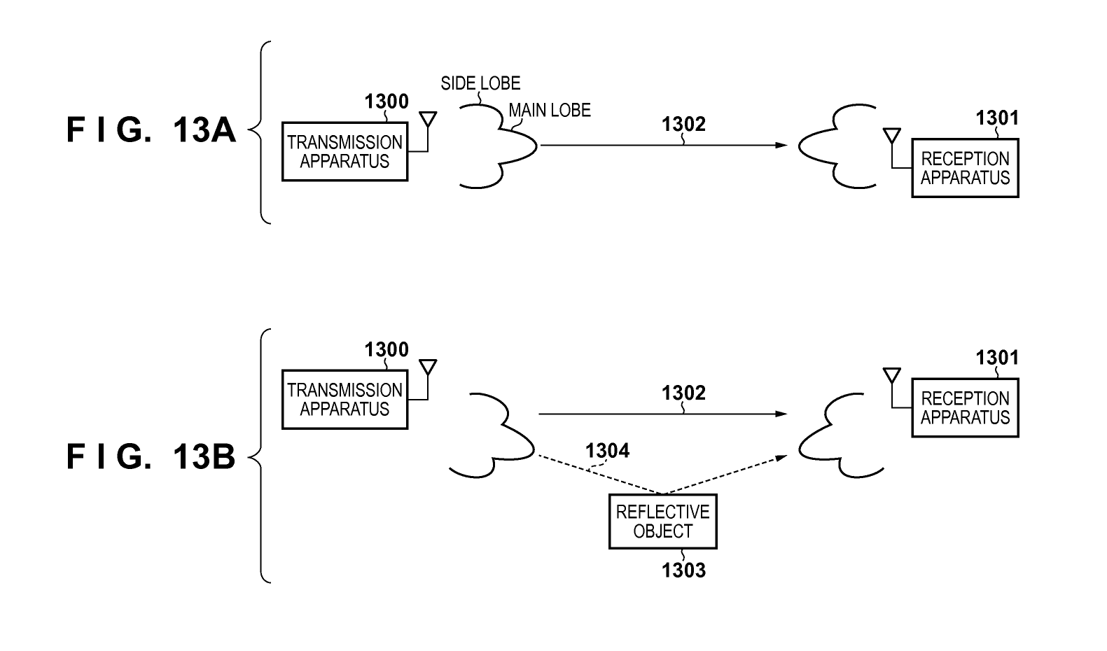

An outline of processing executed by the source node 100 and destination node 101 according to this embodiment will be described. In this embodiment, if different pairs of the directions of directivity of the transmission antenna and reception antenna use the same communication path, as shown in FIGS. 13A and 13B, the plurality of different pairs of the directions of directivity are regarded as one group. While only one pair of the directions of directivity is extracted from each group as a candidate of a pair of the directions of directivity to be used for communication, at least one (two or more, if possible) pair of the directions of directivity to be used for communication is selected from the extracted pairs of the directions of directivity. This makes it possible to select a plurality of pairs of the directions of directivity which form different communication paths.

As shown in FIG. 13A, for example, if the source node 100 and destination node 101 set the directions of directivity of the transmission antenna and reception antenna to 90°, respectively, communication via a communication path 1302 becomes possible using the main lobes. On the other hand, in this embodiment, there are side lobes in the ±15° directions with respect to the direction of directivity. Therefore, when the suppression level of the side lobes is low, even if the directions of directivity of the transmission antenna and reception antenna are set to 75° (or 105°), respectively, the communicable communication path 1302 is formed, as shown in FIG. 13B. In such case, a case in which the directions of directivity of the transmission antenna and reception antenna are set to 90° and a case in which the directions of directivity are set to 75° (or) 105° are regarded as one group. One pair of the directions of directivity of the transmission antenna and reception antenna is then selected from the one group. Similarly, as for other communication paths, if there are a plurality of pairs of directions of directivity which form the same path, the plurality of pairs of the directions of directivity are regarded as one group, and one pair of the directions of directivity is extracted from the group as a candidate.

Note that in the example shown in FIG. 13B, if a communication path 1304 having high communication quality is formed in the main lobe direction, communication via the communication path 1304 is possible even if the communication path 1302 is blocked. In this case, therefore, it is determined that the communication path formed in the example of FIG. 13A is different from that formed in the example of FIG. 13B, and these communication paths are not included in one group. This enables the source node 100 and destination node 101 to readily select a plurality of spatially different communication paths. Practical apparatuses, an example of the structure of a signal, an example of processing, and the like for implementing the above method will be described below.

(Frame Format)

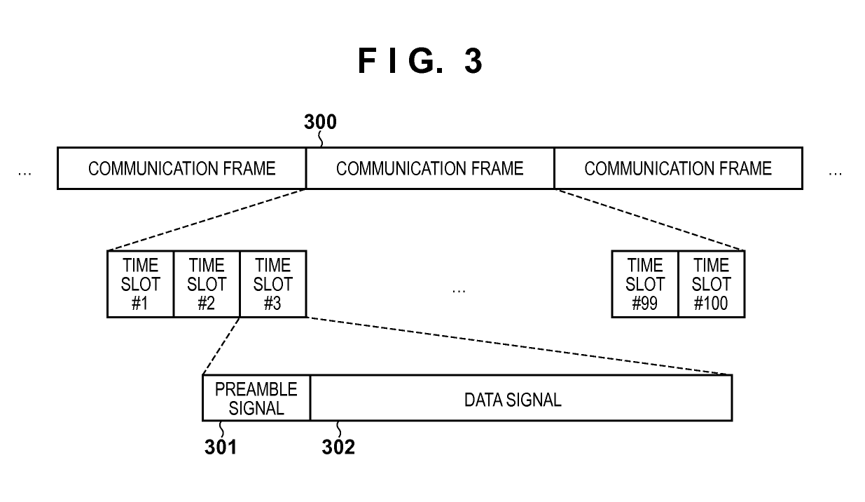

FIG. 3 shows an example of the format of a communication frame transmitted/received between the source node 100 and the destination node 101. As shown in FIG. 3, in this embodiment, a communication frame 300 having a fixed length is repeatedly transmitted/received at a predetermined period. The communication frame 300 is divided by time into a predetermined number (100 in this embodiment) of time slots. Each time slot includes a preamble signal 301 and a data signal 302. The reception apparatus ensures timing synchronization based on the preamble signal, and performs demodulation processing for the data signal according to the timing. In the first time slot (time slot #1) of the communication frame, the source node 100 transmits time slot allocation information using the broad directional mode. The time slot allocation information contains, for example, a node for performing transmission in each time slot, the type of data to be transmitted, an antenna mode to be used, and a direction of directivity when the antenna mode is the narrow directional mode. The destination node 101 detects the start of the communication frame 300 by the preamble signal of the time slot #1, and communicates with the source node 100 based on the time slot allocation information of the time slot #1.

(Arrangement of Source Node)

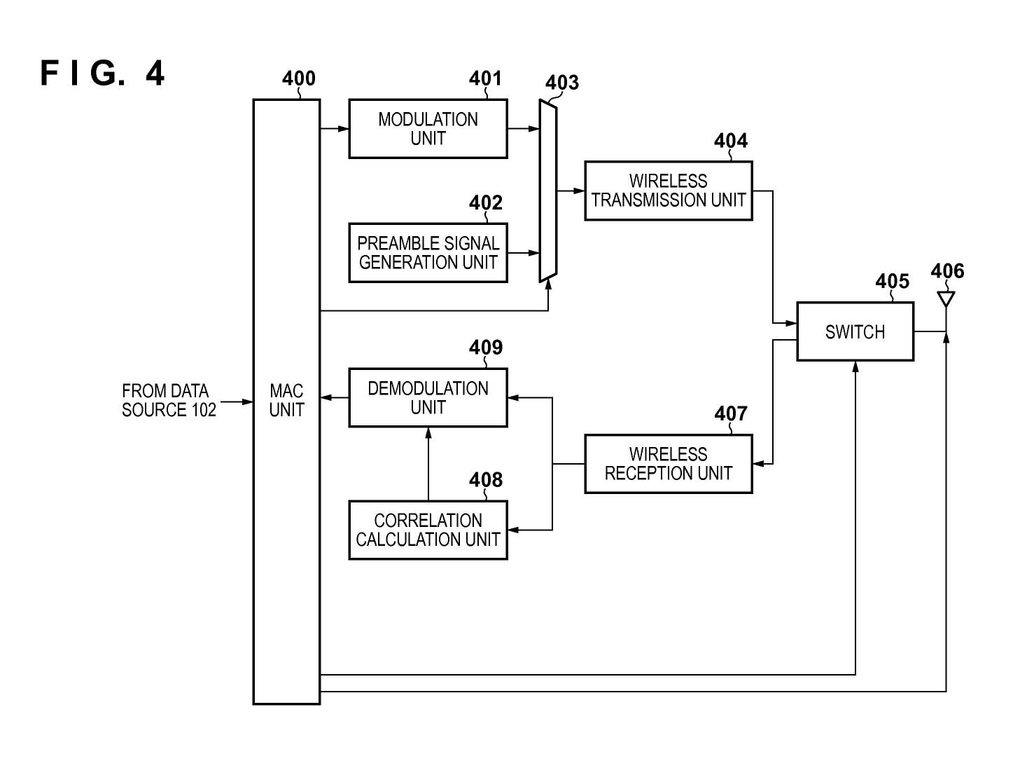

FIG. 4 is a block diagram showing an example of the internal arrangement of the source node 100. The source node 100 includes, for example, a MAC (Media Access Control) unit 400, a modulation unit 401, a preamble signal generation unit 402, a selector 403, a wireless transmission unit 404, a switch 405, and an antenna 406. The source node 100 also includes a wireless reception unit 407, a correlation calculation unit 408, and a demodulation unit 409.

The MAC unit 400 controls each unit so that the video data input from the data source 102 and the control data associated with a search for communication paths are transmitted or received at a predetermined timing in the direction of directivity of the antenna. The modulation unit 401 generates a baseband data signal by modulating data input from the MAC unit 400 using OFDM modulation as a modulation scheme, and outputs the generated data signal to the selector 403. The preamble signal generation unit 402 generates a preamble signal under the control of the MAC unit 400, and outputs the generated preamble signal to the selector 403. Note that the waveform of the preamble signal is known by the destination node 101. This makes it possible to estimate and obtain the impulse response of a transmission line by performing correlation detection in the destination node 101.

Let s(t) be a preamble signal transmitted by the source node 100, and h(t) be the impulse response of the transmission line. Then, a preamble signal r(t) received by the destination node 101 is given by:

r(t)=h(t)*s(t) (1)

where “*” represents a convolution integral operator. In this case, the destination node 101 performs a correlation operation for the received signal using the known preamble signal s(t). A result corr(t) of the correlation operation is given by:

corr(t)=r(t)*s(t)=h(t)*s(t)*s(t) (2)

If, therefore, s(t)*s(t)=6 (t) holds for the autocorrelation characteristics of the preamble signal where δ(t) is the delta function,

corr(t)=h(t) (3)

Consequently, the destination node 101 can obtain the impulse response of the transmission line by performing correlation operation for the received signal using the known preamble signal.

Under the control of the MAC unit, the selector 403 outputs the signal input from the modulation unit 401 or preamble signal generation unit 402 to the wireless transmission unit 404. The wireless transmission unit 404 includes a DAC (Digital Analog Converter), a frequency conversion circuit, and a power amplification circuit, and converts the input signal into a signal with a radio frequency (RF) and outputs it to the switch 405.

Under the control of the MAC unit 400, the switch 405 connects the antenna 406 to one of the wireless transmission unit 404 and the wireless reception unit 407. The antenna 406 transmits or receives a signal in the mode in the direction of directivity under the control of the MAC unit 400.

The wireless reception unit 407 includes an ADC (Analog Digital Converter), a frequency conversion circuit, and an automatic gain controlling circuit, and converts the received signal with the radio frequency into a baseband signal and outputs it to the correlation calculation unit 408 and demodulation unit 409. The correlation calculation unit 408 obtains the impulse response of the transmission line by performing correlation operation between the input baseband signal and the known preamble signal, and outputs the impulse response to the demodulation unit 409. The demodulation unit 409 determines the reception timing of the preamble signal based on the impulse response of the transmission line input from the correlation calculation unit 408. The demodulation unit 409 decides the timing of demodulation processing based on the determined timing, demodulates the baseband signal input from the wireless reception unit 407, and outputs the demodulated data to the MAC unit 400.

(Arrangement of Destination Node)

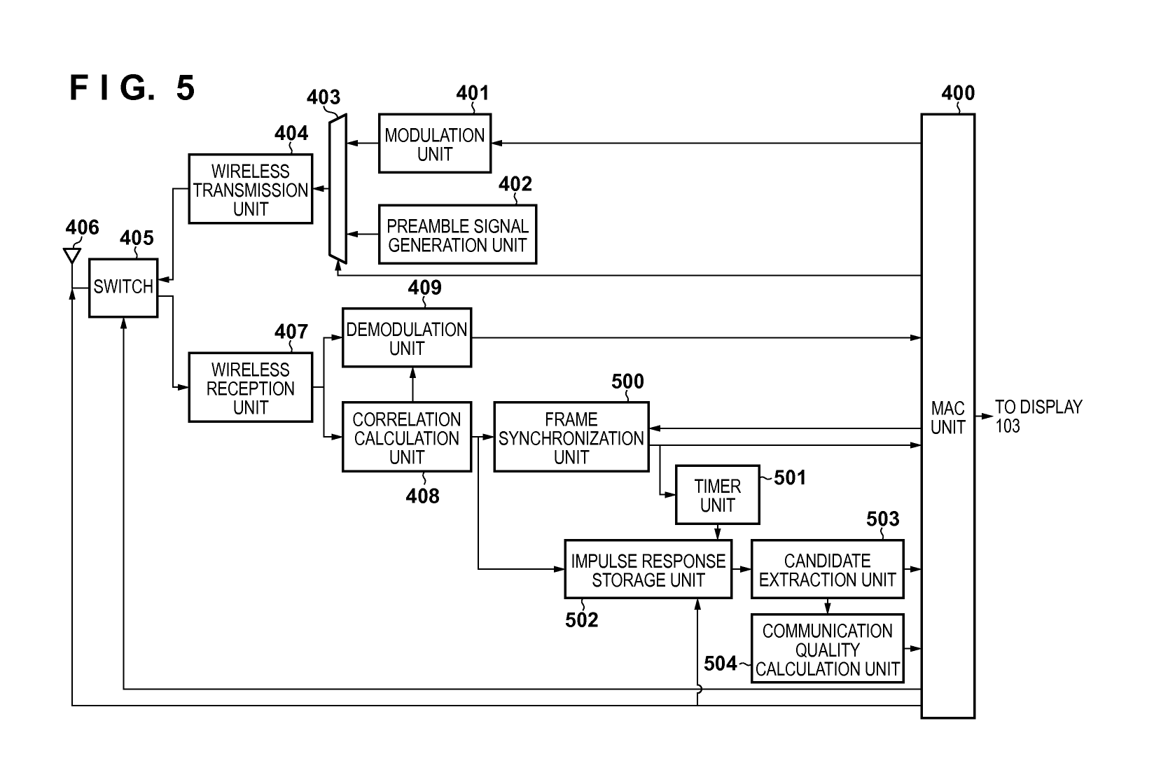

FIG. 5 is a block diagram showing an example of the internal arrangement of the destination node 101. Note that in FIG. 5, blocks having the same functions as those of the blocks forming the source node 100 described with reference to FIG. 4 have the same reference numerals, and a description thereof will be omitted. The destination node 101 includes a frame synchronization unit 500, a timer unit 501, an impulse response storage unit 502, a candidate extraction unit 503, and a communication quality calculation unit 504.

The correlation calculation unit 408 inputs the impulse response of the transmission line to the frame synchronization unit 500. Under the control of the MAC unit 400, the frame synchronization unit 500 detects the preamble signal of the time slot #1 transmitted by the source node 100 in the broad directional mode for each communication frame, and notifies the MAC unit 400 and timer unit 501 of the start of the communication frame.

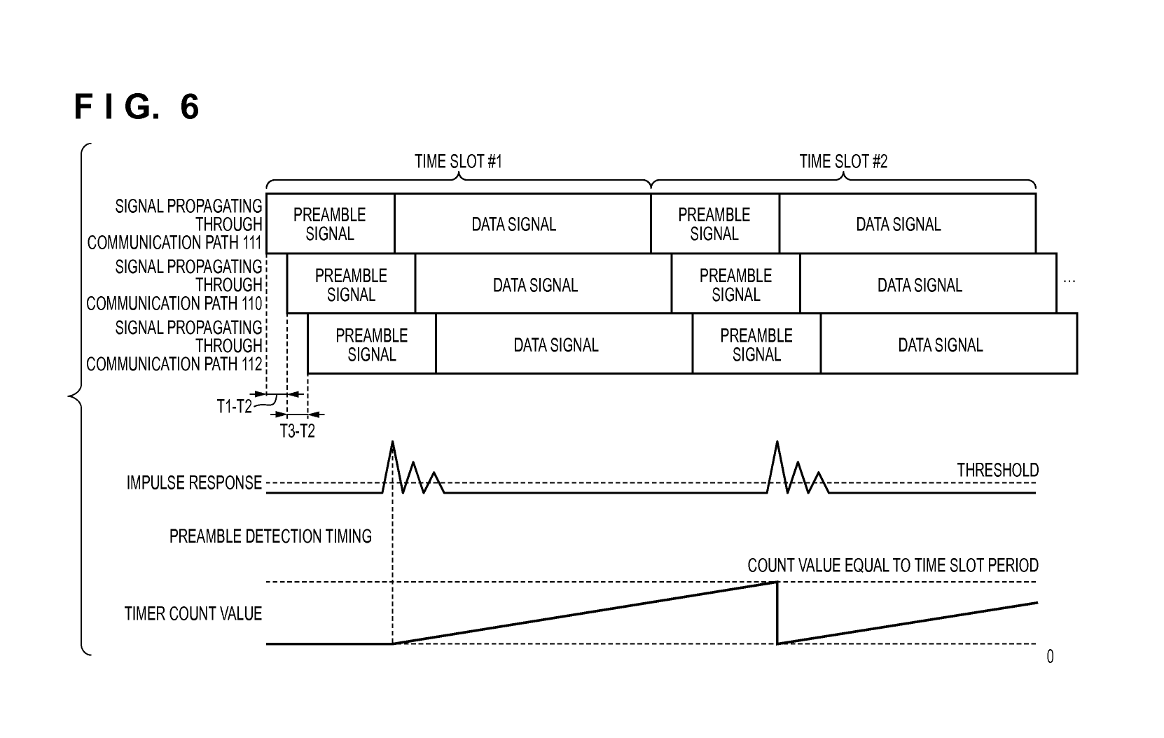

FIG. 6 is a view showing the operation of the frame synchronization unit 500. The preamble signal of the time slot #1 transmitted by the source node 100 in the broad directional mode propagates through each of the communication paths 110 to 112 shown in FIG. 1, and received by the destination node 101. The frame synchronization unit 500 sets, as the detection timing of the preamble signal, the timing when the amplitude of the impulse response of the transmission line input from the correlation calculation unit 408 exceeds a predetermined threshold, and notifies the MAC unit 400 and timer unit 501 of the timing. As shown in FIG. 6, the timer unit 501 starts to count up a count value from 0 at the start timing of the communication frame, and then resets the count value to 0 at a time slot period to count up the count value.

At the time of a search for communication paths, the impulse response storage unit 502 stores the direction of directivity of the antenna, the impulse response of the transmission line, and the timer count value in association with each other. Note that the impulse response storage unit 502 need not store the whole information of the impulse response, and may store, for example, the time of arrival of a main wave in the impulse response of the transmission line. Note that the main wave indicates, for example, a radio wave which arrives when the amplitude of the impulse response becomes largest. Alternatively, a radio wave which has an amplitude equal to or larger than a predetermined value and arrives at the earliest timing may be set as a main wave.

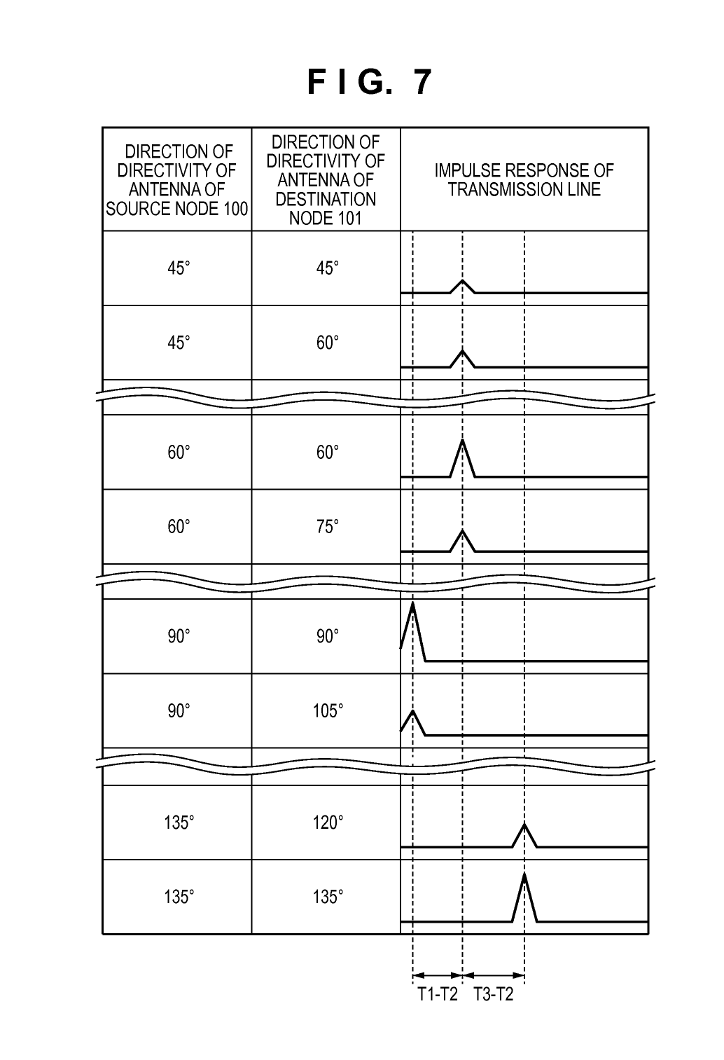

FIG. 7 is a table showing an example of information stored in the impulse response storage unit 502. FIG. 7 shows an impulse response when attention is paid to only a main wave for the sake of simplicity. Note that when both the directions of directivity of the transmission antenna and reception antenna are 60°, 90°, or 135°, a radio wave emitted from the main lobe of the transmission antenna is received by the main lobe of the reception antenna. In this case, assume that a signal propagates through each of the communication paths 110, 111, and 112 shown in FIG. 1, and the propagation times of the communication paths are represented by T1, T2, and T3, respectively. As described above, each of the transmission antenna and reception antenna according to this embodiment has the peaks of the side lobes in the ±15° directions with respect to the direction of directivity. Even if, therefore, the direction of directivity of at least one of the transmission antenna and reception antenna shifts by 15° from that in each of the above-described examples, the signal can be received by the side lobe. If, for example, the direction of directivity of the transmission antenna is 45° and the direction of directivity of the reception antenna is 60°, a radio wave emitted by the side lobe of the transmission antenna can be received by the main lobe of the reception antenna.

The propagation time of the signal which arrives via each of the communication paths 110 to 112 is not different between a case in which the signal is transmitted/received by the main lobes and a case in which the signal is transmitted/received by the side lobes. That is, when the times of arrival of the main waves coincide with each other or shift from each other within a sufficiently short predetermined period in the impulse responses, even if the pairs of the directions of directivity of the antennas are different from each other, it can be estimated that the signals have arrived via the same communication path.

Since the gain of the main lobe is higher than that of the side lobe, the amplitude of the impulse response of the transmission line when the signal is transmitted/received by the main lobes is larger than that of the impulse response of the transmission line when the signal is transmitted/received by the side lobes. Among a plurality of pairs of the directions of directivity of the antennas in which the times of arrival of the main waves coincide or almost coincide with each other, a pair of the directions of directivity in which the peak amplitude of the impulse response is largest is determined as a pair of the directions of directivity in which a radio wave emitted by the main lobe of the transmission antenna can be received by the main lobe of the reception antenna.

According to this principle, the candidate extraction unit 503 selects directions of directivity in which communication is possible using the main lobes, based on the time of arrival of the main wave in the impulse response for each pair of the directions of directivity, and sets the selected directions of directivity as a candidate of a pair of the directions of directivity to be used for communication. When, for example, the times of arrival of the main waves coincide with each other or the difference between the times of arrival is shorter than a predetermined time, if there are two or more pairs of the directions of directivity, the candidate extraction unit 503 determines that communication is performed using the same communication path in the pairs of the directions of directivity. The candidate extraction unit 503 then groups all the pairs of the directions of directivity by including, in one group, the two or more pairs of the directions of directivity for which it has been determined that communication is performed using the same communication path. After that, the candidate extraction unit 503 selects only one pair of the directions of directivity from each group, and extracts it as a candidate of a pair of the directions of directivity to be used for communication. With this processing, for the candidates of the pairs of the directions of directivity extracted by the candidate extraction unit 503, the difference between the time of arrival of the main wave when one candidate is used and that of the main wave when another candidate is used is always equal to or longer than the predetermined time. That is, it is possible to ensure that communication is performed via different communication paths by selecting and using different candidates. Note that information about the pairs of the directions of directivity is output to the communication quality calculation unit 504.

Note that the candidate extraction unit 503 may extract a pair of the directions of directivity in which the amplitude of the main wave is largest as a candidate of a pair of the directions of directivity to be used for subsequent communication. Alternatively, the candidate extraction unit 503 may select, in each group, one of pairs of the directions of directivity in which the amplitude of the main wave is equal to or larger than a predetermined value, and extract it as a candidate of a pair of the directions of directivity.

For the candidate of the pair of the directions of directivity to be used for communication, which has been received from the candidate extraction unit 503, the communication quality calculation unit 504 outputs, to the MAC unit 400, a largest value of the amplitude of the impulse response of the transmission line as the communication quality when the candidate is used. Note that the communication quality calculation unit 504 may specify the delay dispersion of the impulse response, and determine the communication quality based on the delay dispersion. By using the delay dispersion, the communication quality is determined in consideration of the power and the time of arrival of a delayed wave as an interference component as well as the power and the time of arrival of the main wave. This makes it possible to more accurately calculate the communication quality in the multipath environment. The communication quality calculation unit 504 may use, as an index of the communication quality, the result of calculating EVM (Error Vector Magnitude) or BER (Bit Error Rate) in the demodulation unit 409.

(Operation of Wireless Communication System)

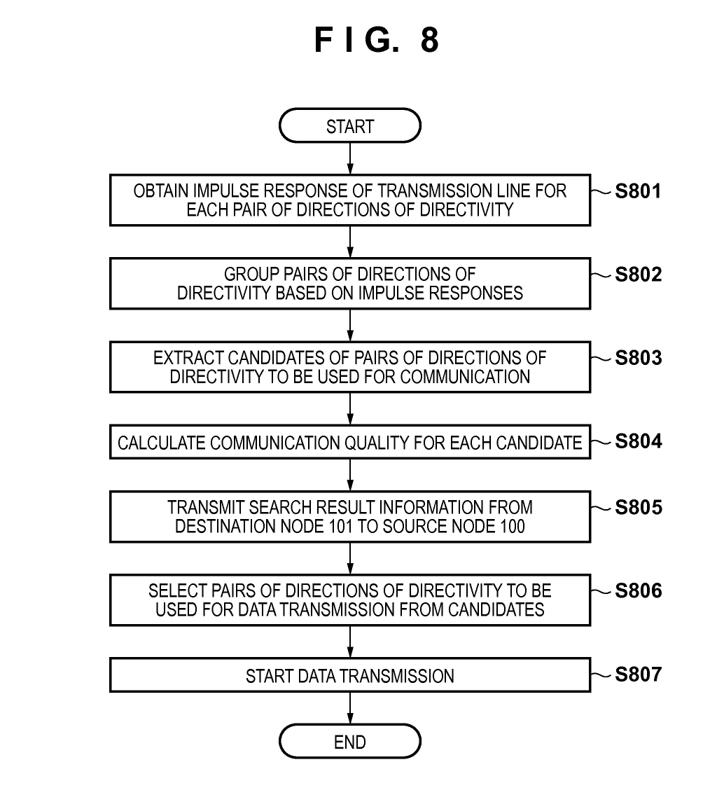

The operation of the wireless communication system according to this embodiment will be described next. FIG. 8 is a flowchart illustrating processing executed by the wireless communication system. In this processing, the source node 100 and destination node 101 obtain the impulse response of the transmission line for each pair of the directions of directivity while changing the directions of directivity of the transmission antenna and reception antenna (step S801). More specifically, the source node 100 includes information of the directions of directivity to be used in each time slot in time slot allocation information for a search for communication paths, and transmits the information to the destination node 101 in the time slot #1. The source node 100 and destination node 101 search for communication paths using the directions of directivity defined in the time slot allocation information in each time slot.

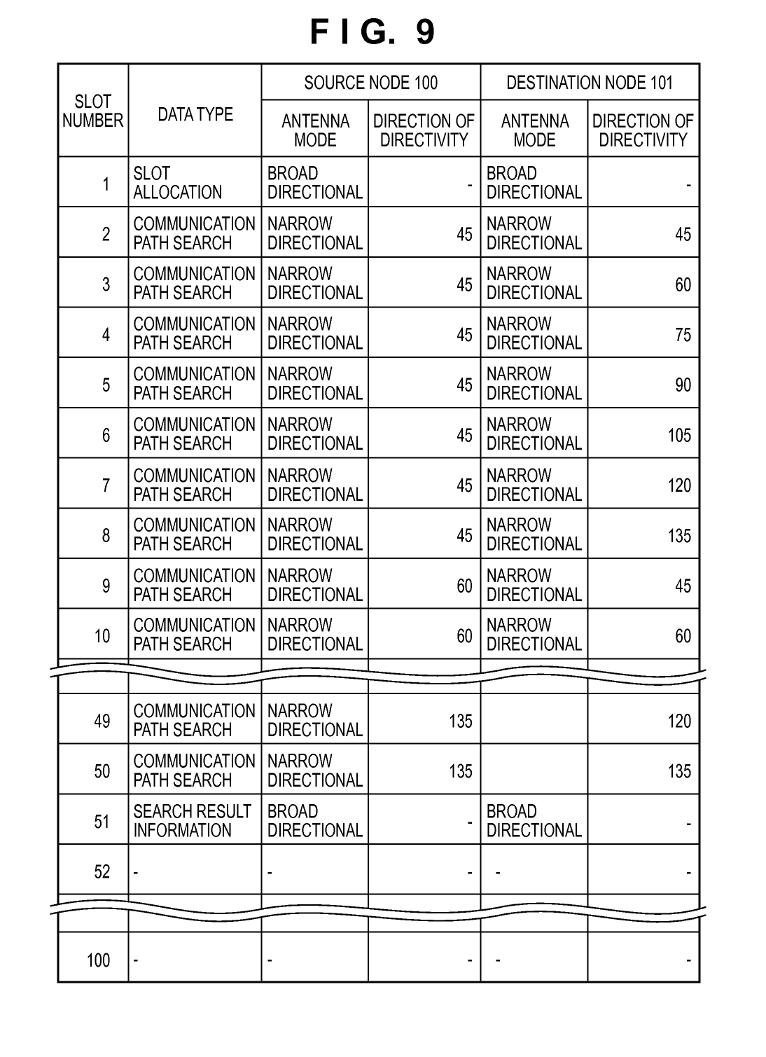

At this time, the time slot allocation information is, for example, information shown in FIG. 9. The source node 100 notifies the destination node 101 of the time slot allocation information shown in FIG. 9 in the time slot #1. In time slots #2 to #50, the source node 100 and destination node 101 set the directions of directivity of the antennas according to the sent time slot allocation information, and search for communication paths for all the pairs of the directions of directivity. In a time slot #51, the destination node 101 transmits, to the source node 100, information indicating candidates of pairs of the directions of directivity to be used for communication and communication quality for each candidate, which is obtained as a result of the search for communication paths. Note that at the time of a search for communication paths, the source node 100 need only transmit at least a preamble signal to the destination node 101, and the contents of data transmitted at this time may be arbitrary data.

Based on the impulse response of the transmission line for each pair of the directions of directivity, the destination node 101 groups the pairs of the directions of directivity for which the impulse responses have been obtained so that pairs of the directions of directivity in which the times of arrival of the main waves almost coincide with each other are included in one group. With this operation, pairs of the directions of directivity in which the same communication path may be used for communication are included in one group. Referring to FIG. 7, for example, cases in which the directions of directivity of the antennas of the source node 100 and destination node 101 are 60°±15° (pairs of the directions of directivity in which communication is performed via the communication path 110) are grouped into group 1. Similarly, cases in which the directions of directivity of the antennas of the source node 100 and destination node 101 are 90°±15° (pairs of the directions of directivity in which communication is performed via the communication path 111) are grouped into group 2. Furthermore, cases in which the directions of directivity of the antennas of the source node 100 and destination node 101 are 135°±15° (pairs of the directions of directivity in which communication is performed via the communication path 112) are grouped into group 3.

The destination node 101 extracts one candidate of a pair of the directions of directivity to be used for communication for each group obtained in step S802 (step S803). For example, the destination node 101 determines, as a pair of the directions of directivity in which communication is performed by the main lobes, a pair of the directions of directivity in which the amplitude of the main wave in the impulse response of the transmission line is largest among the pairs of the directions of directivity included in one group, and extracts the pair as a candidate. Alternatively, for example, the destination node 101 may extract, as a candidate, a pair of the directions of directivity in which the communication quality of the main wave in the impulse response of the transmission line is highest among the pairs of the directions of directivity included in one group. Alternatively, the destination node 101 may select one of pairs of the directions of directivity in which the magnitude of the amplitude or the communication quality of the main wave in the impulse response of the transmission line is equal to or larger than a predetermined value among the pairs of the directions of directivity included in one group, and extract the selected pair as a candidate.

For example, in FIG. 7, as a candidate of a pair of the directions of directivity to be used for communication, the destination node 101 extracts 60° as the direction of directivity of the transmission antenna and 60° as the direction of directivity of the reception antenna from group 1. Similarly, as a candidate of a pair of the directions of directivity to be used for communication, the destination node 101 extracts 90° as the directions of directivity of the transmission antenna and reception antenna from group 2, and extracts 135° as the directions of directivity of the transmission antenna and reception antenna from group 3.

The destination node 101 calculates the communication quality for each candidate of the pair of the directions of directivity extracted in step S803 (step S804). After that, the destination node 101 transmits, as search result information, the candidates of the pair of the directions of directivity to be used for communication and the communication quality to the source node 100 in the time slot #50 (step S805).

The source node 100 specifies pairs of the directions of directivity which satisfy predetermined communication quality among the candidates of the pairs of the directions of directivity received from the destination node 101, and arbitrarily selects two pairs of the directions of directivity from the specified pairs of the directions of directivity (step S806). In this embodiment, for example, the source node 100 selects, as pairs of the directions of directivity to be used for data transmission, two pairs of the directions of directivity, one pair including the directions of directivity of the transmission antenna and reception antenna which are 60° (the communication path 110) and the other including the directions of directivity of the transmission antenna and reception antenna which are 90° (the communication path 111).

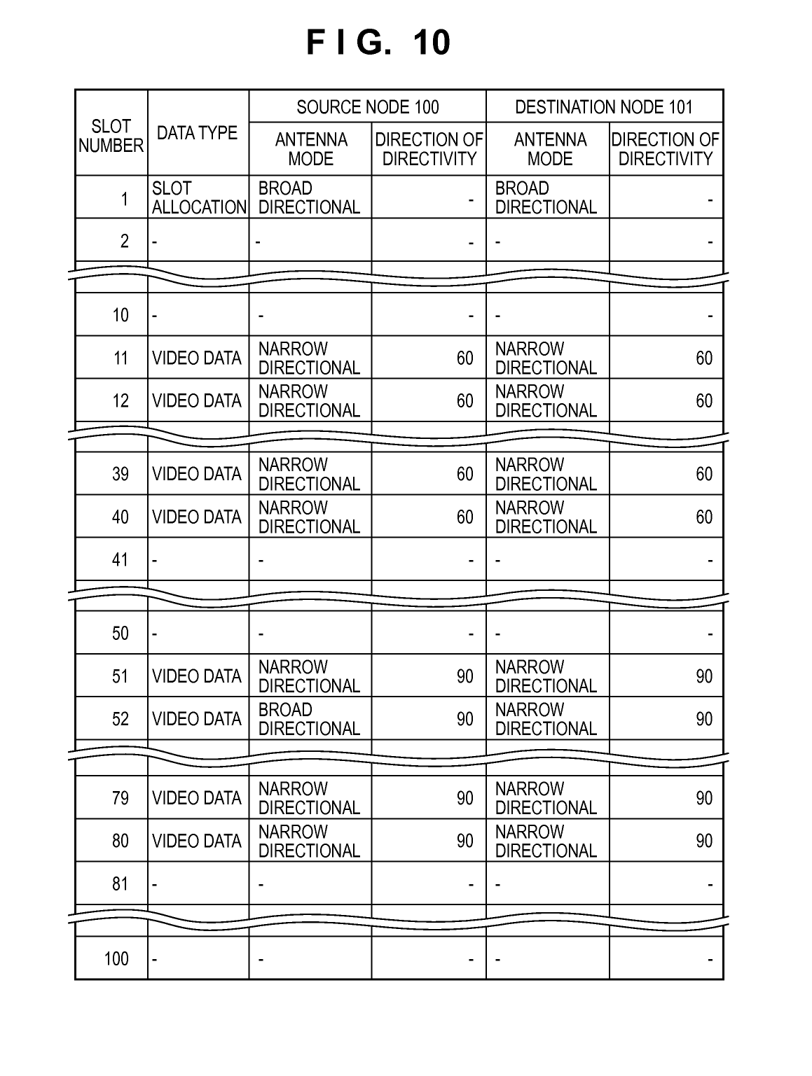

The source node 100 decides, for example, time slot allocation shown in FIG. 10 based on the selected pairs of the directions of directivity. The source node 100 notifies the destination node 101 of the decided time slot allocation information in the time slot #1, and then transmits the video data to the destination node 101 according to the time slot allocation information. In the example of FIG. 10, in time slots #11 to #30 or #51 to #80, both the directions of directivity of the transmission antenna and reception antenna are set to 60° (the communication path 110) or 90° (the communication path 111). The data is transmitted using the pairs of the directions of directivity.

With the above processing, it is possible to avoid using a communication path formed by the side lobes, and select a plurality of spatially different communication paths using the main lobes. Even if one communication path is blocked, it is possible to reduce the probability that another communication path is blocked at the same time, thereby implementing a reliable system operation with, for example, a low probability that a video playback operation is interrupted.

### Second Embodiment

In this embodiment, a pair of the directions of directivity of the antennas of a source node 100 and destination node 101, which is optimum for communication, is searched for by calculating the communication quality for each of all the pairs of the directions of directivity of the antennas. In the multipath environment, the delay dispersion of a communication path formed by the side lobes may be smaller than that of a communication path formed by the main lobes. In such case, in this embodiment, the communication path formed by the side lobes is selected to further improve the reliability of communication by focusing on that point.

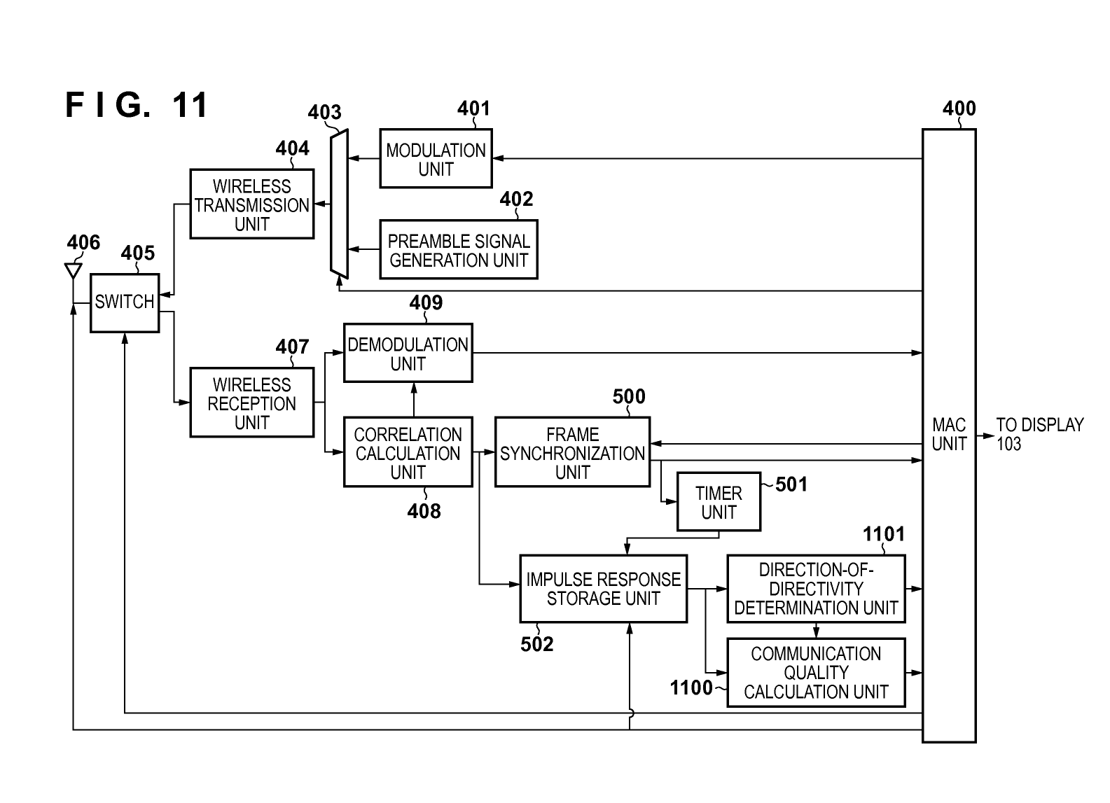

FIG. 11 is a block diagram showing an example of the arrangement of the destination node 101 according to this embodiment. Referring to FIG. 11, blocks having the same functions as those of the blocks of the destination node 101 shown in FIG. 5 have the same reference numerals, and a description thereof will be omitted. The destination node 101 according to this embodiment includes a communication quality calculation unit 1100 and a direction-of-directivity determination unit 1101.

The communication quality calculation unit 1100 calculates the communication quality for each of all the pairs of the directions of directivity of the antennas of the source node 100 and destination node 101. For example, the communication quality may be calculated based on the delay dispersion, or calculated using EVM. The direction-of-directivity determination unit 1101 groups one or more pairs of the directions of directivity in which the times of arrival of the main waves in the impulse responses of a transmission line almost coincide with each other into one group, similarly to the candidate extraction unit 503 of the first embodiment. For each group, a pair of the directions of directivity having the highest communication quality is determined as a pair of the directions of directivity optimum for communication in the group, and output to a MAC unit 400 as a candidate of a pair of the directions of directivity to be used for communication. Note that the direction-of-directivity determination unit 1101 may select, in each group, one of pairs of the directions of directivity whose communication quality is higher than a predetermined value, and output the selected pair of the directions of directivity as a candidate of a pair of the directions of directivity to be used for communication. That is, if there are a plurality of pairs of the directions of directivity in which it is possible to ensure sufficient communication quality, setting one of the plurality of pairs of the directions of directivity as a candidate can ensure communication quality. Therefore, even a pair of the directions of directivity whose communication quality is not highest may be selected as a candidate of a pair of the directions of directivity to be used for communication.

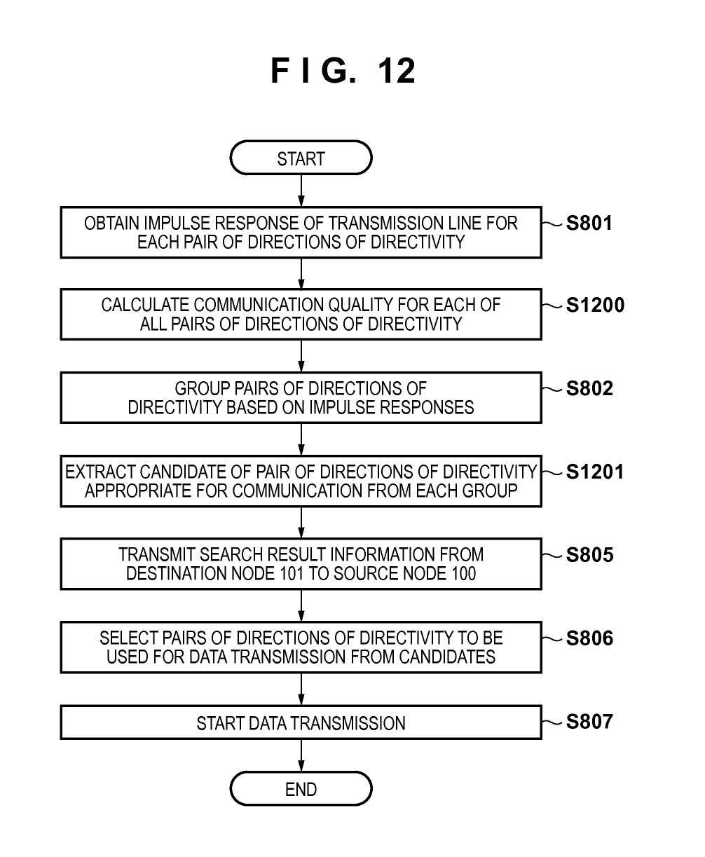

FIG. 12 is a flowchart illustrating processing in a wireless communication system according to this embodiment. Referring to FIG. 12, portions for executing the same processes as in FIG. 9 have the same reference symbols and a description thereof will be omitted.

In this processing, in step S1200, the destination node 101 calculates the communication quality for each of all the pairs of the directions of directivity of the antennas of the source node 100 and destination node 101. After grouping the pairs of the directions of directivity based on the times of arrival of the main waves, the destination node 101 specifies a pair of the directions of directivity whose communication quality is highest for each group in step S1201. The destination node 101 extracts a pair of the directions of directivity optimum for communication (a pair of the directions of directivity whose communication quality is highest) in each group as a candidate of a pair of the directions of directivity to be used. That is, a pair of the directions of directivity in which a communication path is formed by the side lobes has communication quality higher than that of a pair of the directions of directivity in which a communication path is formed by the main lobes, the former pair of the directions of directivity is extracted as a candidate of a pair of the directions of directivity to be used for communication. After that, a communication path to be used for video data transmission is selected, and the video data is transmitted, similarly to the first embodiment.

The above processing makes it possible to select a plurality of spatially separated communication paths, and form each communication path using an optimum pair of the directions of directivity of the antennas to make communication.

Note that in the above-described embodiment, data transmission is performed by selecting two candidates of pairs of the directions of directivity from a plurality of candidates of pairs of the directions of directivity which satisfy predetermined communication quality. The present invention, however, is not limited to this. For example, three or more candidates of pairs of the directions of directivity may be selected. Alternatively, for example, if there is only one candidate of a pair of the directions of directivity which satisfies the predetermined communication quality, only the candidate may be selected. In this case, when one communication path is blocked, communication may be disconnected. However, since it is possible to know that there is only one communication path established in advance, for example, it is possible to prompt the user to move the node to a location where a plurality of spatially separated communication paths can be established.

In the above-described embodiment, data transmission is performed by arbitrarily selecting two or more candidates of pairs of the directions of directivity among the plurality of candidates of pairs of the directions of directivity which satisfy the predetermined communication quality. However, candidates of pairs of the directions of directivity to be used for data transmission may be selected according to a predetermined rule. For example, as a plurality of communication paths used for data transmission are spatially separated farther away from each other, the probability that all the communication paths are simultaneously disconnected by a shielding object is lower. That is, the source node 100 may select two or more candidates of pairs of the directions of directivity so that the directions of directivity of the candidates are spatially separated. As described above, the covariance of the directions of directivity of the antennas can be used as an index for selecting candidates of pairs of the directions of directivity. Assume, for example, that there are N candidates of pairs of the directions of directivity which satisfy the predetermined communication quality. Let θs(n) be the direction of directivity of the transmission antenna of the nth candidate, and θd(n) be the direction of directivity of the reception antenna. If the n₁th, n₂th, . . . , n_{M}th candidates are selected from the N candidates of the pairs of the directions of directivity, the covariance σ of the directions of directivity of the antennas is calculated by:

$$σ = \frac{1}{M} {\sum }_{m = 1}^{M} ( θ s ( {n}_{m} ) - \frac{1}{M} {\sum }_{i = 1}^{M} θ s ( {n}_{i} ) ) \times ( θ d ( {n}_{m} ) - \frac{1}{M} {\sum }_{i = 1}^{M} θ d ( {n}_{i} ) )$$

As the absolute value of the covariance is larger, a plurality of selected communication paths are spatially separated farther away from each other. Therefore, a covariance value is calculated for each of at least some of combinations, which is obtained by selecting a predetermined number of candidates from all the candidates of the pairs of the directions of directivity, and a combination whose absolute value of the covariance is largest is selected to be used for data transmission. In this embodiment, there are three combinations each obtained by selecting two communication paths from communication paths 110 to 112. When the two communication paths 110 and 112 are selected, the absolute value of the covariance of the directions of directivity of the antennas is largest. That is, selecting and using the pair of the directions of directivity in which the two communication paths are used allows reliable communication with a low probability that all the communication paths are simultaneously disconnected.

Note that instead of combinations of a predetermined number of pairs of the directions of directivity whose absolute value of the covariance is largest, a combination whose absolute value of the covariance exceeds a predetermined value may be specified. If a plurality of such combinations exist, one of the plurality of combinations may be selected and used. With this operation, it is also possible to select a combination of pairs of the directions of directivity whose absolute value of the covariance of the directions of directivity of the antennas is sufficiently high, thereby reducing the probability that all the communication paths are simultaneously disconnected.

Note that the roles of the source node 100 and destination node 101 are not limited to the above-described ones. For example, in the above-described embodiments, the destination node 101 extracts candidates of pairs of the directions of directivity, and the source node 100 selects two or more pairs of directions of directivity to be used among the candidates. However, the source node 100 or destination node 101 may solely execute all the above processes. That is, for example, the source node 100 may obtain information of the impulse responses of the transmission lines, especially information of the times of arrival of the main waves for a plurality of pairs of the directions of directivity of the antennas, and execute the subsequent processing. More specifically, the source node 100 may calculate and obtain information about an impulse response by receiving information of an impulse response from the destination node 101 or causing the destination node 101 to transmit a signal for a search for communication paths, and execute the subsequent processing. Similarly, instead of transmitting the candidates of the pairs of the directions of directivity to the source node 100, the destination node 101 itself may decide a pair of the directions of directivity to be used for communication from the candidates, and notify the source node 100 of the pair of the directions of directivity to be used. As described above, the above-described respective processes can be executed by the source node 100 and destination node 101 by appropriately dividing them, or executed by the source node 100 or destination node 101 alone. In either case, it is possible to extract candidates of pairs of the directions of directivity so that the difference between the time of arrival of the main wave for one candidate of a pair of the directions of directivity to be used for communication and that of the main wave for another candidate is equal to or longer than a predetermined time. Therefore, in either case, a plurality of spatially separated communication paths can be selected.

According to the present invention, when selecting a plurality of communication paths, it is possible to select spatially different communication paths.

### OTHER EMBODIMENTS

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-117377, filed Jun. 3, 2013, which is hereby incorporated by reference herein in its entirety.

What is claimed is:

1. A communication system comprising a transmission apparatus which includes a transmission antenna capable of changing a direction of directivity and a reception apparatus which includes a reception antenna capable of changing a direction of directivity,
one of said transmission apparatus and said reception apparatus comprising
an obtaining unit configured to obtain a time of arrival of a radio wave for each of a plurality of pairs of the directions of directivity of said transmission antenna and said reception antenna, and
an extraction unit configured to extract a pair of the directions of directivity to be used for communication, and extract a plurality of pairs so that a difference between the time of arrival for one of the pairs and the time of arrival for another one of the pairs is not shorter than a predetermined time.

2. The system according to claim 1, wherein said extraction unit groups at least two pairs of the directions of directivity in which the difference between the times of arrival of the radio waves is shorter than the predetermined time, and extracts one pair of the directions of directivity as a candidate from the group.

3. The system according to claim 2, wherein said extraction unit extracts, as the candidate, a pair of the directions of directivity in which an amplitude of the radio wave is largest among the at least two pairs of the directions of directivity included in the group.

4. The system according to claim 2, wherein said extraction unit extracts, as the candidate, a pair of the directions of directivity in which communication quality of the radio wave is highest among the at least two pairs of the directions of directivity included in the group.

5. The system according to claim 2, wherein one of said transmission apparatus and said reception apparatus includes a selection unit configured to select at least one pair of the directions of directivity to be used for communication from the candidates.

6. The system according to claim 5, wherein said selection unit selects a pair of the directions of directivity to be used for communication from the candidates which satisfy predetermined communication quality.

7. The system according to claim 6, wherein said selection unit calculates the communication quality of the candidate using a power of the radio wave and an interference power of from a delayed wave, and selects a pair of the directions of directivity to be used for communication by determining whether the communication quality satisfies the predetermined communication quality.

8. The system according to claim 5, wherein said selection unit calculates a covariance of the directions of directivity for each of at least some of combinations of a predetermined number of pairs of the directions of directivity included in the candidates, and selects the predetermined number of pairs of the directions of directivity to be used for communication based on an absolute value of the covariance.

9. The system according to claim 8, wherein a combination of the predetermined number of pairs of the directions of directivity whose absolute value of the covariance is largest is selected as the predetermined number of pairs of the directions of directivity to be used for communication.

10. A control apparatus of a communication system including a transmission apparatus which includes a transmission antenna capable of changing a direction of directivity and a reception apparatus which includes a reception antenna capable of changing a direction of directivity, said control apparatus comprising:
an obtaining unit configured to obtain a time of arrival of a radio wave for each of a plurality of pairs of the directions of directivity of the transmission antenna and the reception antenna, and
an extraction unit configured to extract a pair of the directions of directivity to be used for communication, and extract a plurality of pairs so that a difference between the time of arrival for one of the pairs and the time of arrival for another one of the pairs is not shorter than a predetermined time.

11. The apparatus according to claim 10, wherein said control apparatus is included in one of the transmission apparatus and the reception apparatus.

12. A control method for a communication system including a transmission apparatus which includes a transmission antenna capable of changing a direction of directivity and a reception apparatus which includes a reception antenna capable of changing a direction of directivity, the method comprising:
obtaining a time of arrival of a radio wave for each of a plurality of pairs of the directions of directivity of the transmission antenna and the reception antenna; and
extracting a pair of the directions of directivity to be used for communication, and extracting a plurality of pairs so that a difference between the time of arrival for one of the pairs and the time of arrival for another one of the pairs is not shorter than a predetermined time.

13. A storage medium storing a program for causing a computer, included in a control apparatus of a communication system including a transmission apparatus which includes a transmission antenna capable of changing a direction of directivity and a reception apparatus which includes a reception antenna capable of changing a direction of directivity, to execute
obtaining a time of arrival of a radio wave for each of a plurality of pairs of the directions of directivity of the transmission antenna and the reception antenna, and
extracting a pair of the directions of directivity to be used for communication, and extracting a plurality of pairs so that a difference between the time of arrival for one of the pairs and the time of arrival for another one of the pairs is not shorter than a predetermined time.
